(19) United States
(12) Patent Application Publication
(10) Pub. No.: US 2026/0079673 A1
(43) Pub. Date: Mar. 19, 2026

(54) RANDOM NUMBER GENERATOR

(71) Applicant: SK hynix Inc., Gyeonggi-do (KR)

(72) Inventor: Kwang Jun CHO, Gyeonggi-do (KR)

(21) Appl. No.: 19/004,457

(22) Filed: Dec. 30, 2024

(30) Foreign Application Priority Data
Sep. 13, 2024 (KR) 10-2024-0125605

(51) Int. Cl. G06F 7/58

(52) U.S. Cl. CPC G06F 7/582

(57) ABSTRACT

A random number generator includes a noise generator including a plurality of diodes, and configured to generate a noise signal corresponding to a leakage current of at least one diode selected from among the plurality of diodes; an analog-to-digital converter configured to convert the noise signal into at least one random code; and a random code processor configured to generate a random number by processing the random code.

### CROSS-REFERENCE TO RELATED APPLICATION

This patent application claims the priority and benefits of Korean patent application No. 10-2024-0125605, filed on Sep. 13, 2024, the disclosure of which is incorporated herein by reference in its entirety.

### TECHNICAL FIELD

The technology and embodiments disclosed in the present disclosure generally relate to a random number generator for generating random numbers using a diode array.

### BACKGROUND

Recently, research and development has been conducted on various security technologies for preventing data exposure during data communication. The most widely used technology among these security technologies is a technology for encrypting data using an encryption key. The encryption key needs to be structured so that others cannot easily infer the encryption key. In order to generate the encryption key, different and unpredictable numbers (i.e., random numbers) are required. It is important for random numbers to be used for the encryption key to have characteristics of being unexpected, uncorrelated, and unbiased. It is also important to secure a random number generator capable of generating such random numbers having the above-described characteristics.

### SUMMARY

Various embodiments of the present disclosure relate to a random number generator capable of generating random numbers using noise distribution of a diode array.

In accordance with an embodiment of the present disclosure, a random number generator may include a noise generator including a plurality of diodes, and configured to generate a noise signal corresponding to a leakage current of at least one diode selected from among the plurality of diodes; an analog-to-digital converter configured to convert the noise signal into at least one random code; and a random code processor configured to generate a random number by processing the random code.

In accordance with another embodiment of the present disclosure, a random number generator may include a plurality of switching elements connected in parallel to a first node and controlled by a plurality of switching control signals; a plurality of diodes connected between a ground voltage terminal and the plurality of switching elements, respectively, to generate a leakage current; a capacitor connected between the first node and the ground voltage terminal, and configured to accumulate and store the leakage current; a current-to-voltage converter configured to convert the leakage current stored in the capacitor into a voltage as a noise signal; an analog-to-digital converter configured to convert the noise signal into at least one random code; and a random code processor configured to generate a random number by processing the random code, wherein an amount of the leakage current stored in the capacitor is controlled in response to the leakage current of at least one diode selected from among the plurality of diodes.

It is to be understood that both the foregoing general description and the following detailed description of the embodiments of the present disclosure are illustrative and descriptive, and are intended to provide further description of the embodiments as claimed.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a block diagram illustrating a random number generator according to an embodiment of the present disclosure.

FIG. 2 is a circuit diagram illustrating a noise generator shown in FIG. 1 according to an embodiment of the present disclosure.

FIG. 3 is a circuit diagram illustrating another noise generator shown in FIG. 1 according to an embodiment of the present disclosure.

FIGS. 4A to 4C are conceptual diagrams illustrating operations of the random number generator shown in FIG. 1 according to an embodiment of the present disclosure.

FIG. 5 is a diagram illustrating a distribution of random codes generated by the ADC shown in FIG. 1 according to an embodiment of the present disclosure.

### DETAILED DESCRIPTION

This present disclosure provides embodiments and examples of a random number generator for generating random numbers using a diode array that may be used in configurations to substantially address one or more technical or engineering issues and to mitigate limitations or disadvantages encountered in some random number generators in the art. Some embodiments of the present disclosure relate to a random number generator that can generate random numbers using noise distribution of a diode array. In recognition of the issues above, the random number generator according to the embodiments can generate random numbers using noise distribution of a diode array, and can easily implement a device that has characteristics of being unbiased, uncorrelated, and having a high possibility of being highly unpredictable.

Reference will now be made in detail to some embodiments of the present disclosure, which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized.

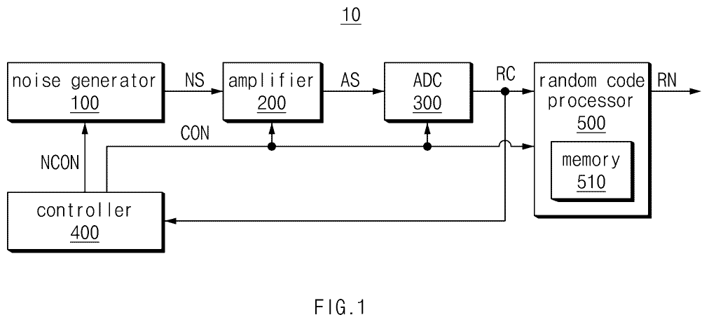

FIG. 1 is a block diagram illustrating a random number generator 10 according to an embodiment of the present disclosure.

Referring to FIG. 1, the random number generator 10 may include a noise generator 100, an amplifier 200, an analog-to-digital converter (ADC) 300, a controller 400, and a random code processor 500.

The noise generator 100 may generate a noise signal NS using a leakage current of a diode array. The noise signal NS generated by the noise generator 100 may be randomly controlled by a noise control signal NCON.

For example, according to the embodiment of the present disclosure, the noise generator 100 may include a diode having a PN junction structure using a Complementary Metal Oxide Semiconductor (CMOS) process. For example, the diode may be designed to operate in reverse bias to generate a high leakage current. A depletion region may be formed in the middle of the PN junction of the diode. In this depletion region, noise may be generated randomly due to deterioration phenomena, etc., caused by randomness in a semiconductor fabrication process. For example, in the case of a CMOS image sensor, a diode having a P-N junction structure with a deep depletion layer may be used.

That is, according to the embodiment of the present disclosure, the diode having a PN junction structure may serve as a thermal noise source, and may have excellent randomness in the time domain. The noise sources generated by the diode array are not necessarily limited to thermal noise sources, and can be anything that can provide irregular noise signals by exploiting physical phenomena that are difficult to predict.

According to the embodiment of the present disclosure, since digital data corresponding to a leakage current of the diode array having random characteristics is used as a seed value of the random code processor 500, the random number generator 10 can be implemented without separate hardware.

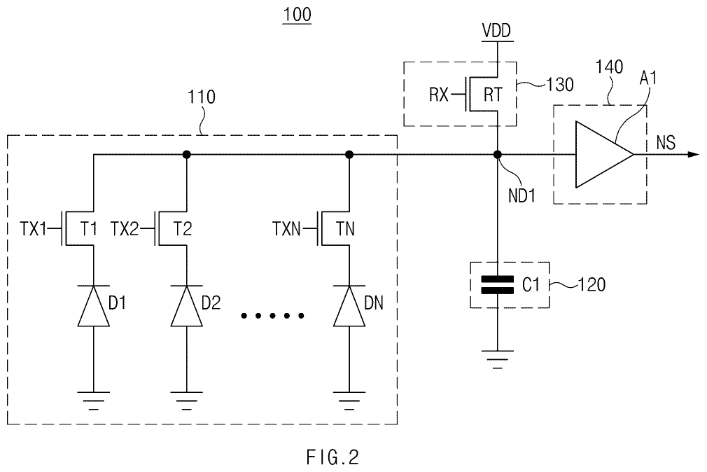

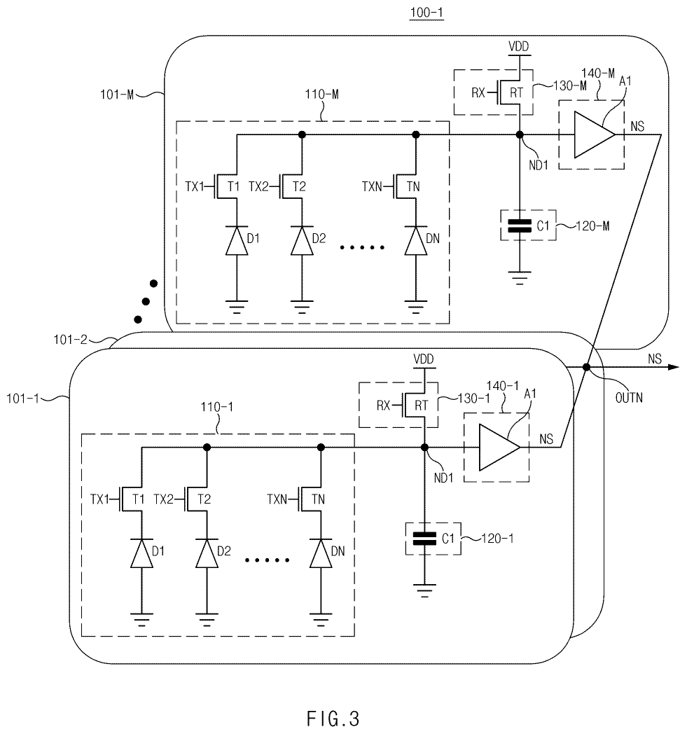

The embodiment of the present disclosure will describe generating the noise signal NS using the diode array, and a detailed configuration of the noise generator 100 will be described later with reference to FIGS. 2 and 3.

The embodiment of the present disclosure has disclosed that the diode array is applied to a CMOS image sensor for convenience. However, the scope or spirit of the embodiment of the present disclosure is not limited thereto, and can be applied to various embodiments using a CMOS process.

The embodiment of the present disclosure has disclosed that the diode has a PN junction structure for convenience. However, the scope or spirit of the embodiment of the present disclosure is not limited thereto, and the diode may have an NP junction structure, a PNP junction structure, an NPN junction structure, or other junction structures.

The amplifier 200 may amplify the noise signal NS generated by the noise generator 100, and may output the amplified analog signal AS. The amplification operation of the amplifier 200 may be controlled by a control signal CON received from the controller 400. The amplifier 200 may generate the amplified analog signal AS by applying an analog gain to the noise signal NS. When the voltage level of the noise signal NS is amplified by the amplifier 200, noise dispersion may also increase.

For example, the amplifier 200 may include a variable gain amplifier (VGA), a programmable gain amplifier (PGA), etc., but the type of the gain amplifier is not limited thereto.

The embodiment of the present disclosure has disclosed that the noise signal NS generated by the noise generator 100 is amplified by the amplifier 200 and is then output as an analog signal AS for convenience. However, the scope or spirit of the embodiment of the present disclosure is not limited thereto, and according to the embodiment, the configuration of the amplifier 200 may be omitted and the noise signal NS may be output as an unaltered analog signal AS. The analog signal AS is merely a signal obtained by amplifying the voltage level of the noise signal NS, and the noise signal NS may be an analog signal AS.

The ADC 300 may convert an analog signal AS received from the amplifier 200 into a random code RC serving as a digital signal. The conversion operation of the ADC 300 may be controlled by a control signal CON received from the controller 400. The random code RC output from the ADC 300 may be fed back to the controller 400, and may be input to the controller 400.

The controller 400 may generate a noise control signal NCON for controlling the operation of the noise generator 100. For example, the controller 400 may control the amount of leakage current by adjusting the number of selected diode arrays included in the noise generator 100. According to the embodiment, the controller 400 may receive the random code RC as a feedback signal, and may control the noise control signal NCON based on the distribution of the random code RC.

The controller 400 may generate a control signal CON for controlling the operation of the amplifier 200. For example, the controller 400 may adjust the amplification range of the noise signal NS amplified by the amplifier 200. That is, the controller 400 may control an analog gain value of the amplifier 200 based on the distribution of the random code RC. In another example, the controller 400 may control the operation timing of the amplifier 200.

The controller 400 may generate a control signal CON to control the operation of the ADC 300. For example, the controller 400 may control the number of bits of the random code RC converted by the ADC 300. That is, the controller 400 may control how many times the analog-to-digital conversion operation of the ADC 300 is performed based on the distribution of the random code RC, and may generate a plurality of random codes RC. In another example, the controller 400 may control the output timing of the random code RC output from the ADC 300.

The random code processor 500 may process the random code RC received from the ADC 300 to generate one or more random numbers RN. A random number generated by any physical phenomena may be referred to as a quantum random number. Here, the random number RN may refer to arbitrary random numbers that are different from each other and unpredictable, i.e., randomly generated numbers.

For example, the random code processor 500 may accumulate and store the random code RC received from the ADC 300, and may generate random numbers RN using the distribution of the stored digital codes.

In some embodiments, the random code processor 500 may include a buffer that temporarily stores the random code RC or a memory 510 that accumulates and stores the random code RC. In some embodiments, the random code processor 500 may generate random numbers RN by summing a plurality of accumulated random codes RC (digital code values) to increase the distribution of the random code RC. In some embodiments, the random number RN generated by the random code processor 500 may be stored in the memory 510 or may be output to an external device (e.g., a processor).

In some embodiments, the random code processor 500 may be used as a deterministic random bit generator (DRBG). The deterministic random bit generator (DBRG) may refer to a device or algorithm that generates random numbers using a deterministic algorithm. The deterministic algorithm may refer to an algorithm that has unique characteristics of generating the same output signal in response to the same input signal.

Representative examples of the deterministic random bit generator (DBRG) may include a block cipher-based random number generator, a hash function-based random number generator, and an HMAC-based random number generator. Here, the block cipher-based random number generator is a random number generator that uses a counter mode of the block cipher, which is referred to as CTR_DRBG. The hash function-based random number generator is a random number generator that uses the hash function, which is referred to as Hash_DRBG. The HMAC-based random number generator is a random number generator that uses the HMAC algorithm, which is referred to as HMAC_DRBG. Although examples of the random code processor 500 have been described above, the type of the random code processor 500 is not limited thereto, and other types of the random code processor 500 can also be used as needed.

FIG. 2 is a circuit diagram illustrating the noise generator 100 shown in FIG. 1 according to an embodiment of the present disclosure.

Referring to FIG. 2, the noise generator 100 may include a diode array circuit 110, a capacitor circuit 120, a reset circuit 130, and a current-to-voltage converter 140.

The diode array circuit 110 may generate a leakage current based on a noise control signal NCON received from the controller 400. The diode array circuit 110 may include a plurality of switching elements T1 to TN and a plurality of diodes D1 to DN.

The plurality of switching elements T1 to TN may be connected in parallel between a node ND1 and the plurality of diodes D1 to DN, respectively. For example, the plurality of switching elements T1 to TN may be NMOS transistors. The switching operation of the plurality of switching elements T1 to TN may be controlled by a plurality of switching control signals TX1 to TXN. Here, the plurality of switching control signals TX1 to TXN may be signals included in the noise control signal NCON. In some embodiments, the plurality of switching control signals TX1 to TXN may be activated sequentially. According to another embodiment, the plurality of switching control signals TX1 to TXN may be selectively and randomly activated.

The plurality of diodes D1 to DN may be connected in parallel between the plurality of switching elements T1 to TN and a ground voltage terminal. The anodes of the plurality of diodes D1 to DN may be connected to the ground voltage terminal, and the cathodes of the plurality of diodes D1 to DN may be commonly connected to the node ND1. For example, the plurality of diodes D1 to DN may be connected in a reverse direction between the ground voltage terminal and the plurality of switching elements T1 to TN.

For example, when the switching control signal TX1 is activated to a logic high level, the switching element T1 may be turned on so that the diode D1 may be connected to the node ND1. When the switching control signal TX2 is activated to a logic high level, the switching element T2 may be turned on so that the diode D2 can be connected to the node ND1. When the switching control signal TXN is activated to a logic high level, the switching element TN may be turned on so that the diode DN can be connected to the node ND1.

That is, depending on how many of the switching elements T1 to TN are turned on, the number of diodes D1 to DN connected to the node ND1 may be changed, and the amount of leakage current accumulated and stored in the capacitor C1 may be controlled differently.

The random number generator according to the embodiment of the present disclosure may utilize an arbitrary physical phenomenon called leakage current to generate random numbers. That is, the random number generator may utilize a leakage current of the diodes D1 to DN as a noise source required to generate random numbers.

For example, the leakage current generated by the diodes may be thermal noise that is randomly generated due to randomness in the semiconductor fabrication process. In another example, a leakage current of a photodiode used in the CMOS image sensor is used as a noise source for generating random numbers. The photodiode may be designed to measure photons. The leakage current generated by such diodes represents a current generated when no light is incident upon the photodiode and, as such, may be referred to as dark current. In some embodiments, when a pinned photodiode having a PN junction is included in the diode array circuit 110, the dark current generated by the diodes D1 to DN when no light is incident upon the diode array circuit 110, rather than a photocurrent generated by the diodes D1-DN when light is incident upon the diode array circuit 110, may be used as a noise source.

The capacitor circuit 120 may include a capacitor C1 for storing charges therein. The capacitor C1 may be connected between the node ND1 and the ground voltage terminal. The capacitor C1 may accumulate and store electrons of leakage current received from the plurality of diodes D1 to DN through the node ND1. The electrons of the leakage current accumulated in the capacitor C1 for a specific time may be used as a seed value of the random number generator 10. Since the leakage currents of the plurality of diodes D1 to DN selected by the plurality of switching elements T1 to TN are accumulated and stored in the capacitor C1, the noise distribution that becomes a seed value of the random number generator can be randomly secured.

For example, the capacitor C1 may be a metal-insulator-metal (MIM) capacitor in which two electrodes have a conductive material, or a metal-insulator-semiconductor (MIS) capacitor in which one of two electrodes has a conductive material and the other one has a semiconductor material, but the type and structure of such capacitors are not limited thereto.

The embodiment of the present disclosure has disclosed that one capacitor C1 is provided corresponding to N diodes D1 to DN. However, the scope or spirit of the embodiment of the present disclosure is not limited thereto, and the number of capacitors may also be sufficiently changed in response to an increase or decrease in the number of diodes.

In addition, the reset circuit 130 may include a reset element RT. The reset element RT may be connected between the power supply voltage terminal and the node ND1 to reset the node ND1 to the power supply voltage level. The reset element RT may be an NMOS transistor controlled by a reset signal RX. Here, the reset signal RX may be a signal included in the noise control signal NCON. For example, when the reset signal RX is activated to a logic high level, the reset element RT may be turned on to reset the node ND1 to the power supply voltage level.

The current-to-voltage converter 140 may convert the leakage current applied to the node ND1 into a voltage, and may output a noise signal NS. For example, the current-to-voltage converter 140 may include an amplifier A1 to amplify the leakage current, and may convert the amplified current into a voltage.

FIG. 3 is a circuit diagram illustrating another noise generator 100 shown in FIG. 1.

Referring to FIG. 3, a noise generator 100-1 according to another embodiment of the present disclosure may include a plurality of noise generation blocks 101-1 to 101-M.

The noise generation block 100-1 may include a diode array circuit 110-1, a capacitor circuit 120-1, a reset circuit 130-1, and a current-to-voltage converter 140-1. The noise generation block 100-M may include a diode array circuit 110-M, a capacitor circuit 120-M, a reset circuit 130-M, and a current-to-voltage converter 140-M.

Since the detailed circuit configuration of each of the plurality of noise generation blocks 101-1 to 101-M of FIG. 3 is the same or similar to those of FIG. 2, the same reference numerals of FIG. 3 are used for the same components as those of FIG. 2, and as such, the redundant description thereof will herein be omitted for brevity.

The plurality of noise generation blocks 101-1 to 101-M may share an output node OUTN. For example, the output terminals of the current-voltage converter 140-M respectively included in the noise generation blocks 101-1 to 101-M may be commonly connected to the output node OUTN. A plurality of noise generation blocks 101-1 to 101-M may output a noise signal NS through the output node OUTN.

In some embodiments, multiple noise generation blocks 101-1 to 101-M may be activated at the same timing point. According to another embodiment, the plurality of noise generation blocks 101-1 to 101-M may be selectively activated at different timing points.

In the embodiment of FIG. 3, the dispersion of noise may increase compared to the embodiment of FIG. 2. That is, in the embodiment of FIG. 3, when the number of diodes D1 to DN included in each of multiple noise generation blocks 101-1 to 101-M is N and the number of multiple noise generation blocks 101-1 to 101-M is M, the leakage current may increase and the dispersion of noise may also be amplified. When a noise signal NS is generated by the noise generator 100-1 shown in FIG. 3, multiple random codes RC having random code dispersion may be generated.

In some embodiments, the controller 400 may store a reference value for generating random numbers RN. The controller 400 may receive the random code RC as a feedback signal, and may accumulate and store the received random code RC. The controller 400 may compare the distribution of the random code RC with a preset reference value. When the dispersion of the random code RC is less than or equal to the reference value, the controller 400 may control the noise control signal NCON to increase the dispersion characteristics.

For example, when the dispersion of the random code RC is less than or equal to the reference value, the controller 400 may increase the number of diodes D1 to DN to be selected within the noise generation block 101-1, and may thus increase the noise dispersion. In another example, when the dispersion of the random code RC is less than or equal to the reference value, the controller 400 may increase the number of blocks to be selected from among the plurality of noise generation blocks 101-1 to 101-M, and may thus increase the noise dispersion. That is, when the noise dispersion of the random code RC is insufficiently obtained when the controller 400 selects the noise generation block 101-1, the controller 400 may additionally activate the noise generation blocks 101-2 to 101-M, thereby increasing the noise dispersion more randomly.

In some embodiments, the number and order of diodes to be selected by the controller 400, the number and order of noise generation blocks to be selected by the controller 400, etc. may be sufficiently changed, without being limited thereto.

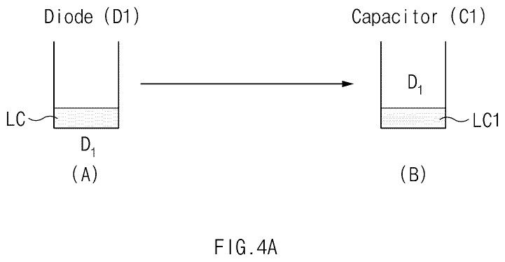

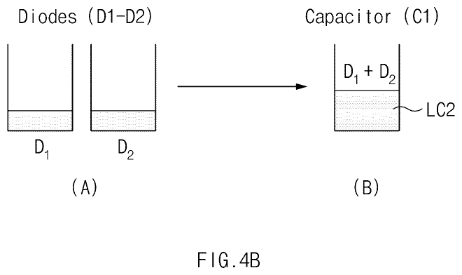

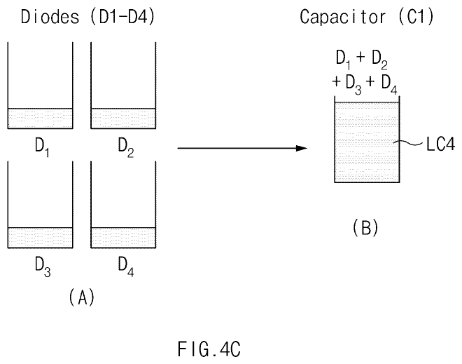

FIGS. 4A to 4C are conceptual diagrams illustrating operations of the random number generator 10 shown in FIG. 1 according to an embodiment of the present disclosure.

Referring to FIGS. 4A to 4C, the diode array circuit 110 of FIG. 2 may adjust the number of diodes D1 to DN to be selected according to how many of the switching elements T1 to TN are turned on, so that the amount of leakage current stored in the capacitor C1 can be randomly changed.

(A) of FIGS. 4A to 4C represents the amount of leakage current LC generated in each of the diodes D1 to DN. In FIG. 4A, when the switching control signal TX1 among the plurality of switching control signals TX1 to TXN is activated, one switching element T1 may be turned on, so that the leakage current generated by the diode D1 may be output to the node ND1. In FIG. 4B, when the switching control signals TX1, TX2 among the plurality of switching control signals TX1 to TXN are activated, two switching elements T1, T2 are turned on, so that the leakage current generated by the diodes D1, D2 may be output to the node ND1. In FIG. 4C, when all of the switching control signals TX1 to TXN (e.g., TX1 to TX4) are activated, all of the N switching elements T1 to TN (e.g., T1 to T4) are turned on, so that the leakage current generated by the diodes D1 to DN (e.g., D1 to D4) may be output to the node ND1.

The leakage current transferred from the diode array circuit 110 to the node ND1 may be accumulated and stored in one capacitor C1. As shown in (B) of FIGS. 4A to 4C, it can be seen that the number of diodes D1 to DN to be selected according to how many of the switching control signals TX1 to TXN are turned on is changed so that the amount of leakage current accumulated and stored in one capacitor C1 can also be changed.

In FIG. 4A, when one switching element T1 is turned on based on the switching control signal TX1, the leakage current LC1 generated by the diode D1 may be stored in the capacitor C1. In FIG. 4B, when two switching elements T1, T2 are turned on based on the switching control signals TX1, TX2, the leakage current LC2 generated by the diodes D1, D2 may be stored in the capacitor C1. For example, the amount of the leakage current LC2 may be about twice that of the leakage current LC1. In FIG. 4C, when all switching elements T1 to T4 are turned on based on the switching control signals TX1 to TX4, the leakage current LC4 generated by the diodes D1 to D4 may be stored in the capacitor C1. For example, the amount of the leakage current LC4 may be about twice that of the leakage current LC2.

When electrons are accumulated in the capacitor C1 for a predetermined period of time, the leakage current stored in the capacitor C1 may be output to the current-to-voltage converter 140 through the node ND1. The current-to-voltage converter 140 may convert the leakage current applied to the node ND1 into a voltage and may thus output a noise signal NS. For example, the current-to-voltage converter 140 may amplify the leakage current stored in the capacitor C1, may convert the amplified leakage current into an analog voltage value, and may thus output the noise signal NS.

As described above, the number of diodes D1 to D4 to be selected according to how many of the switching elements T1 to TN are turned on may be changed, and thus the amount of noise to be accumulated in the capacitor C1 may also be changed. An example of generating the noise signal NS by the noise generator 100 will be described in more detail with reference to Table 1 below.

TABLE 1

| | Electrons | | Noise of | Electron | |
|---|---|---|---|---|---|
| | (e-) | Electrons (e-) | Leakage | readout | |
| Selected | generated by | stored in | Current | noise | ADC |
| diodes | Diode | Capacitor | (e- rms) | (σ_read) | output(RC) |
| D1 | N (4) | N(4) | \sqrt{N} | 1.5 | N ± \sqrt{N} + |
| | | | (\sqrt{4} = 2.00) | | σ_read |
| D1, D2 | N (4) | 2N(8) | \sqrt{2N} | 1.5 | 2N ± \sqrt{2N} + |
| | | | (\sqrt{8} = 2.83) | | σ_read |
| D1, D2, | N (4) | 4N(16) | \sqrt{4N} | 1.5 | 4N ± \sqrt{4N} + |
| D3, D4 | | | (\sqrt{16} = 4.00) | | σ_read |

In Table 1, an electron value N of the leakage current generated by each diode D1 to DN will hereinafter be defined as, for example, “4”. The leakage current stored in the capacitor C1 may be the sum of randomly generated electrons. Therefore, the sum of the leakage currents generated by two diodes D1, D2 may be denoted by 2N (for example, may be doubled). The sum of the leakage currents generated by four diodes D1 to DN may be denoted by 4N (for example, may be quadrupled). In this way, as the number of selected diodes D1 to DN increases, the value of the electrons stored in the capacitor C1 may increase by multiples, such as “4”, “8”, and “16”.

The noise level of the leakage current may be obtained as a root mean square (RMS) value of the noise. Accordingly, it can be seen that as the number of diodes D1 to DN to be selected according to the number of turned-on switching elements T1 to TN increases, the noise of the leakage current to be output to the node ND1 also increases. In addition, the electron readout noise σ_read may be defined as a value of the RMS noise level.

The noise signal NS generated by the noise generator 100 may be converted into a digital signal by the ADC 300. For example, the random code RC to be output from the ADC 300 may be calculated by equations (e.g., N±\sqrt{N}+σ_read, 2N±\sqrt{2N}+σ_read, 4N±\sqrt{4N}+σ_read) described in the above Table 1.

For example, when “4” is applied to “N” in the above equations, the random code RC corresponding to the diode D1 may be generated as values of 3.50 to 7.50, the random code RC corresponding to the diodes D1, D2 may be generated as values of 6.67 to 12.33, and the random code RC corresponding to the diodes D1-DN may be generated as values of 13.50 to 21.50. As described above, it can be seen that the dispersion of the random code RC increases as the number of selected diodes D1-DN increases.

In some embodiments, the noise signal NS generated by the noise generator 100 may be amplified by the amplifier 200 and then transmitted to the ADC 300. That is, the amplifier 200 may apply a gain to the noise signal NS to output an amplified analog signal AS. When the gain is applied to the noise signal NS, a noise level of the analog signal AS may also increase. The ADC 300 may convert the amplified analog signal AS into a digital signal and may output the random code RC to the random code processor 500.

In some embodiments, the random code processor 500 may generate a random number RN by summing random codes RC stored in the memory 510 to increase the dispersion of the random code RC. For example, at least one digital code value from among a random code RC (e.g., 3.50 to 7.50) corresponding to the diode D1, a random code RC (e.g., 6.67 to 12.33) corresponding to the diodes (D1, D2), and a random code RC (e.g., 13.50 to 21.50) corresponding to the diodes D1 to DN may be summed to increase randomness of the random number.

In some embodiments, the random code processor 500 may store a reference value required to generate a random number RN in the memory 510. The random code processor 500 may compare the distribution of the random code RC with a reference value previously stored in the memory 510 based on the control signal CON. When the distribution of the random code RC is less than or equal to the reference value, the random code processor 500 may sum the random codes RC to increase the dispersion characteristics, thereby generating the random number RN.

In the above embodiments, various numerals that represent electron values generated by the diodes D1 to DN, electron values stored in the capacitor C1, the standard deviation of the noise, a value of the random code RC, etc. are merely examples for describing the embodiments of the present disclosure, but the scope or spirit of the embodiments is not limited thereto.

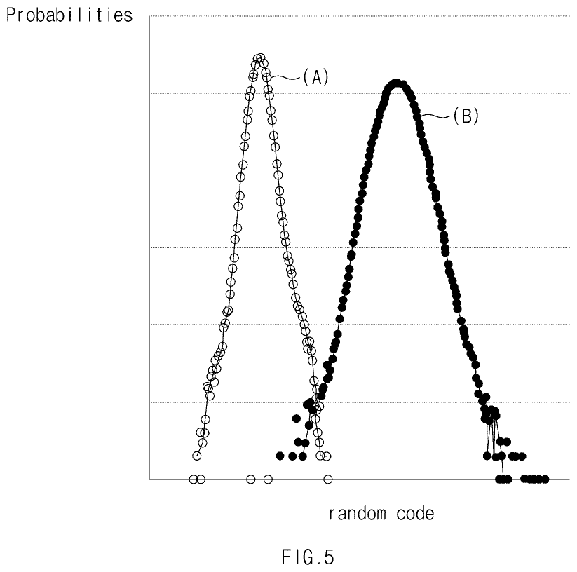

FIG. 5 is a diagram illustrating a distribution of random codes RC generated by the ADC 300 shown in FIG. 1 according to an embodiment of the present disclosure.

In FIG. 5, a horizontal axis may represent the output signal of the ADC 300, that is, digital data (i.e., random code RC), and a vertical axis may represent a numerical value obtained by normalizing the frequency probability (denoted by “probabilities”).

When histogramming of the random code RC output from the ADC 300 is performed, a discrete probability distribution may appear as shown in FIG. 5. For example, the leakage current of the diodes D1 to DN may follow a probability distribution that can be modeled using the Poisson distribution. The Poisson distribution is characterized in that a variance is equal to a square root of a mean value (average value) of the distribution. As a result of such characteristics, a larger leakage current generates a measured current value with a larger variation, which enables a more random number to be created.

For example, the diagram (A) of FIG. 5 represents the distribution of the random code RC corresponding to the leakage current LC1 generated by one diode D1. In (B) of FIG. 5, the leakage currents generated by four diodes D1-DN are accumulated in one capacitor C1 to calculate a summed leakage current LC4, and the dispersion of the random code RC corresponding to the summed leakage current LC4 is described as shown in (B) of FIG. 5.

When the random code RC is generated using a single leakage current LC1, the generated random code RC may have a small value and a sharp distribution as shown in (A) of FIG. 5. When the random code RC is generated using the leakage current LC4 obtained by summing the random codes of the plurality of diodes D1 to DN, the random code RC in (B) of FIG. 5 may have a greater value and a wider distribution than the random code RC in (A) of FIG. 5. Accordingly, the random code processor 500 may generate the random numbers based on the random code RC having a wider distribution, so that the random code processor 500 can improve randomness when generating the random number.

As is apparent from the above description, the random number generator according to the embodiments of the present disclosure may generate random numbers using noise distribution of a diode array, and may easily implement a device that has characteristic of being unbiased, uncorrelated, and having a high possibility of being highly unpredictable.

The embodiments of the present disclosure may provide a variety of effects capable of being directly or indirectly recognized.

Although a number of illustrative embodiments have been described, it should be understood that modifications and enhancements to the disclosed embodiments and other embodiments can be devi sed based on what is described and/or illustrated in the present disclosure. Therefore, the scope of the present disclosure should not be limited to the above-described embodiments but should include the equivalents thereof. Furthermore, the embodiments may be combined to form additional embodiments.

What is claimed is:

1. A random number generator comprising:
a noise generator including a plurality of diodes, and configured to generate a noise signal corresponding to a leakage current of at least one diode selected from among the plurality of diodes;
an analog-to-digital converter configured to convert the noise signal into at least one random code; and
a random code processor configured to generate a random number by processing the random code.

2. The random number generator according to claim 1, wherein
each of the plurality of diodes has a PN junction structure.

3. The random number generator according to claim 1, further comprising:
an amplifier configured to amplify the noise signal and provide the amplified noise signal to the analog-to-digital converter.

4. The random number generator according to claim 1, wherein the noise generator includes:
a diode array circuit in which the number of selected diodes from among the plurality of diodes is adjusted in response to a control signal to control the amount of the leakage current;
a capacitor in which electrons corresponding to the leakage current are accumulated and stored; and
a current-to-voltage converter configured to convert the leakage current stored in the capacitor into a voltage as the noise signal.

5. The random number generator according to claim 4, further comprising:
a reset circuit configured to reset an output node of the capacitor based on a reset signal.

6. The random number generator according to claim 4, wherein the diode array circuit includes:
a plurality of switching elements connected in parallel to a first node, and configured to perform switching operations based on the control signal; and
the plurality of diodes connected in parallel between a ground voltage terminal and the plurality of switching elements, respectively.

7. The random number generator according to claim 6, wherein the plurality of switching elements is sequentially turned on.

8. The random number generator according to claim 6, wherein the plurality of switching elements is selectively and randomly turned on.

9. The random number generator according to claim 6, wherein the plurality of diodes is connected in a reverse direction between the ground voltage terminal and the plurality of switching elements.

10. The random number generator according to claim 6, wherein:
the number of turned-on switching elements from among the plurality of switching elements is adjusted in response to the control signal,
the amount of leakage currents generated by the plurality of diodes is randomly changed, and
the sum of the leakage currents is stored in the capacitor.

11. The random number generator according to claim 10, wherein a noise level of the noise signal is set to a root mean square (RMS) value of the sum of the leakage currents.

12. The random number generator according to claim 11, wherein dispersion of the random code increases in response to an increase in the noise level.

13. The random number generator according to claim 1, further comprising:
a controller that receives the random code as a feedback signal, and generates a noise control signal for controlling the noise generator based on distribution of the random code.

14. The random number generator according to claim 1, wherein the noise generator includes:
a plurality of noise generation blocks configured to output the noise signal through a common output node,
wherein each of the plurality of noise generation blocks includes:
a diode array circuit in which the number of selected diodes from among the plurality of diodes is adjusted in response to a control signal to control the amount of the leakage current;
a capacitor in which electrons corresponding to the leakage current are accumulated and stored; and
a current-to-voltage converter configured to convert the leakage current stored in the capacitor into a voltage as the noise signal.

15. The random number generator according to claim 1, wherein the random code processor further includes a memory configured to store the random code.

16. The random number generator according to claim 1, wherein the random code processor is configured to:
accumulate the random code to generate accumulated random codes; and
generate the random number by summing the accumulated random codes.

17. The random number generator according to claim 1, wherein the random code processor is configured to generate the random number based on distribution of the random code in a discrete probability distribution.

18. A random number generator comprising:
a plurality of switching elements connected in parallel to a first node and controlled by a plurality of switching control signals;
a plurality of diodes connected between a ground voltage terminal and the plurality of switching elements, respectively, to generate a leakage current;
a capacitor connected between the first node and the ground voltage terminal, and configured to accumulate and store the leakage current;
a current-to-voltage converter configured to convert the leakage current stored in the capacitor into a voltage as a noise signal;
an analog-to-digital converter configured to convert the noise signal into at least one random code; and
a random code processor configured to generate a random number by processing the random code,
wherein an amount of the leakage current stored in the capacitor is controlled in response to the leakage current of at least one diode selected from among the plurality of diodes.

19. The random number generator according to claim 18, further comprising an amplifier configured to amplify the noise signal and output the amplified noise signal to the analog-to-digital converter.

20. The random number generator according to claim 18, wherein the random code processor is configured to:
accumulate the random code to generate accumulated random codes;
compare dispersion of the accumulated random codes with a reference value; and
generate the random number by summing the accumulated random codes when the dispersion of the random codes is less than or equal to the reference value.
